(19) United States
(12) Patent Application Publication
(10) Pub. No.: US 2024/0273162 A1
(43) Pub. Date: Aug. 15, 2024

(54) COMMERCIALIZATION SELL SHEET SYSTEM FOR PATENTS AND PUBLISHED PATENT APPLICATIONS AND METHOD

(71) Applicant: Ray Arjomand, Sparks, NV (US)

(72) Inventor: Ray Arjomand, Sparks, NV (US)

(21) Appl. No.: 18/615,995

(22) Filed: Mar. 25, 2024

Related U.S. Application Data
(63) Continuation-in-part of application No. 17/871,803, filed on Jul. 22, 2022, now abandoned.
(60) Provisional application No. 63/224,728, filed on Jul. 22, 2021.

(51) Int. Cl. G06F 16/958; G06F 16/955

(52) U.S. Cl. CPC G06F 16/958; G06F 16/9558

(57) ABSTRACT

The invention is an AI-powered patent search engine that generates a patent search result page on the internet, tailored to the search criteria provided by a user. This page, displayed as the primary window, presents one or more patent documents, with at least one patent document accompanied by a link to a corresponding polychromatic or multicolor sell sheet or specific elements within it, such as a polychromatic image, title, or video. This functionality allows the user with a single input to access a secondary window showcasing a succinct polychromatic sell sheet or layperson's description, polychromatic illustrations, or videos related to the listed patent document. The polychromatic sell sheet or its online location is sourced from the inventor or owner of the patent document. Any layperson—friendly content—text, images, or videos—contained within the polychromatic sell sheet may be incorporated into the AI patent search engine's database.

### CROSS-REFERENCE TO OTHER APPLICATIONS

This application claims the benefit of U.S. Provisional Patent Application No. 63/224,728, filed on Jul. 22, 2021, and entitled “A Repository for Sell Sheets and Patents”, U.S. Non-provisional patent application Ser. No. 17/871,803, filed on Jul. 22, 2022, and entitled “Commercialization Sell Sheet System for Patents and Published Patent Applications and Method” the entire contents of which are incorporated by reference.

### STATEMENT REGARDING FEDERALLY SPONSORED RESEARCH OR DEVELOPMENT

Not Applicable.

### REFERENCE TO A “MICROFICHE APPENDIX”

Not Applicable.

### STATEMENT REGARDING PRIOR DISCLOSURES BY THE INVENTOR OR A JOINT INVENTOR

Not Applicable.

### FIELD OF INVENTION

The present invention may apply to visual computer displays of patents and patent applications and other patent documents obtained through an artificial intelligence internet patent search engine that indexes such patent documents. More specifically, the present invention may be related to the visual presentation of additional data and information not otherwise set forth in the respective patent or patent application substantially relating to enhanced invention understanding, for the respective invention as disclosed by a specific patent or patent application.

### BACKGROUND

A web patent document may be obtained via the web (world-wide-web that may be composed of millions of electronically connected digital documents that are viewed in a web browser) over the internet (e.g., a global network of thousands of servers, computers, and other electronic hardware) via an artificial intelligence (or “AI”) patent search engine, such as USPTO or Google's patent search engine powered by AI, that indexes patents and patent documents. Web patent document, which may be a computer visually presenting image of the documents as published by a patent office (like the United States Patent and Trademark Office), may be time consuming for lay person to read and comprehend due to the web patent document's length, technical nature describing and claiming a respective invention (e.g., often written in a legal, formal or technical language and jargon.) Further, a patent office may restrict the type of visual media that may be submitted as part of a patent application due to the nature of paper publication that an application or resulting patent may be subject to, corresponding national patent law, international patent treaty or the like.

Specialized computer hardware may often be used to execute artificial intelligence (AI) programs faster, and with less energy, such as Lisp machines, neuromorphic engineering, event cameras, and physical neural networks. As of 2023, the market for AI hardware is substantially dominated by CPUs (Central Processing Units). A modern CPU with multiple cores and a high clock speed, such as Intel Core i7 or i9 or AMD Ryzen 7 or 9, is generally recommended for AI. GPU (Graphics Processing Units) that has powerful parallel computing capabilities and is substantially suitable for matrix operations in deep learning tasks. GPUs may be optimized for training artificial intelligence and deep learning models as they can process multiple computations simultaneously. Deep learning models may require a significant amount of memory, especially when working with large datasets or complex architectures. For larger models and datasets an AI machine may require 32 GB or more of memory. Other examples of AI-optimized hardware may include Tensor Processing Units (TPUs); FPGAs (Field-Programmable Gate Arrays); Neuromorphic Chips; Application-Specific Integrated Circuits (ASICs); Data Storage and Management; Data Processing Frameworks; Machine Learning Frameworks; and MLOps Platforms. In this application, a patent search engine using or powered by artificial intelligence may be referred to as “AI Patent Search Engine” for short.

Computer vision or artificial vision is generally seen as a branch of artificial intelligence (AI) that studies and programs algorithms and techniques that allow computers to replicate the processes and functions of the human visual system and to detect and interpret key information through a digital image, video or other visual inputs. In one view, if AI is the discipline that gives computers the ability to think, computer vision may be seen as providing computers with the ability to see, understand and interpret images and videos. The main hardware components required for computer vision applications could be cameras and image sensors for capturing images, I/Os, a communication interface, and a processing unit.

Neural networks, AI, ML, and neuromorphic computing are hardware and software technologies that may be seen as making machines adopt capabilities similar to human behavior and processing. Similarly, computer vision may focus on imitating the complex human vision system and leveraging it in software applications.

Computer vision may be seen as a type of artificial intelligence (AI). The aim could be seen as making computers visualize and understand images or videos in a manner similar to that of humans. This field has grown a lot over the last decade, especially due to the new hardware and algorithms. Further, this type of computation has become faster and more accessible since the amount of data that is generated has also increased.

Capturing data can be seen as an important aspect of computer vision applications, and hardware platforms may play a major role. The main components required for computer vision applications could be cameras and image sensors for capturing images, I/Os, a communication interface, and a processing unit. Imaging sensors present in cameras are characterized by their resolution (number of pixels), speed (frames per second), and number of colors. Depending on the type of computer vision application, the processing unit might vary from CPUs to embedded boards. A few such examples could include CPUs, GPUs, Heterogeneous systems (CPUs+GPUs+others) FPGAs (Field Programmable Gate Arrays), ASICs (Application-Specific Integrated Circuits), Microcontroller boards, Embedded systems (smart cameras), and box 2So.

Traditional computer vision systems may use a camera connected to a general-purpose computer, which may be used to run the application. In a smart camera though, the entire system can be integrated, right from capturing the image to processing the image to setting up the final application. Today, the distinction between smart cameras and development boards has slowly started to fade, since many development boards now may have inbuilt cameras and could be tailored for computer vision applications. With more and more applications being deployed on edge computing, it makes more sense to deploy such devices on development boards. Some critical features that you may need to consider while selecting a development board ability for your computer vision application: high processing speed, edge processing ability, faster access to memory, low power consumption and the like. Certain hardware with embedded platforms constructed substantially for AI could include NVIDIA Jetson and Raspberry Pi Compute, AI accelerators like Google TPU, and SOMs/SBCs containing high-quality imaging sensors.

To successfully deploy computer vision on edge computing, neural network design should be integrated into embedded platforms. These embedded platforms may also call for difficult design decisions to be made around power consumption, cost, accuracy, and flexibility. Overall, for bandwidth, speed, and security reasons, edge computing is critical to computer vision processes. Still, hackers could take advantage of emerging security flaws in artificial intelligence. Designers must take this into consideration too.

Vision processing units (VPUs) could be seen as a specific type of AI accelerator designed for computer vision tasks. VPUs could be well suited for parallel processing. A very popular edge AI accelerator is the Intel Neural Compute Stick 2, which is built on the Myriad X VPU. Intel Neural Compute Stick 2 may offer an easy-to-use USB interface. Pre-trained convolutional network (CNN) models are used in the VPU chips to execute inference tasks. Studies have shown that VPUs are superior to CPUs and GPUs in terms of performance as well as power consumption. Moreover, a combination of multiple VPU hardware chips can even reduce the thermal-design power (TDP) by up to eight times.

Depending on the type of Operating System, Internet Browser or software program used by the end user there may be numerous alternative input devices that may be used for user input to a computer device such as a personal or desktop computer laptop, tablet, smartphone etc. Most users of computer devices use mouse and keyboard as input devices. However, there are numerous other forms of input devices on the market such as ergonomic mice, trackballs, touch/track pads, joysticks, foot mouse, head pointing trackers, eye gaze, voice command, touch screens, Bluetooth devices, digital pens, touchpads on laptops, fingers or stylus or voice command used on smartphones and the like. A mouse-over (also known as a mouse hover) is an action that happens when the user stops or “hovers” the on-screen mouse pointer above a specific element on a computer screen. Holding or “hovering” the mouse in one location then reveals additional information on the screen. Mouse-over control elements are common in web browsers. The mouse enters a spot or area on the screen and a new sub-window opens displaying new information or new images.

The word “a single user input” may include and encompass all these forms of input devices such as Microsoft Windows 10 user interface. However, there may be many other operating systems on the market with different user interfaces such as for example Apple, Google's Android OS, Linux Operating System, and Apple iOS. Apple macOS is found on Apple personal computers such as the Apple Macbook, Apple Macbook Pro and Apple Macbook Air. The single user input may be used generically to include a single click or a single double click, (or a single third click), a right click that opens a menu of options to choose from, hovering over a spot, area or link with an input device, etc., depending on how the respective software may be programmed to operate and the operation may vary depending on the operating system or software program or internet browser used. A single user input may do different things on a screen, including opening different new windows depending on where on the screen, display or window the user inputs and which user input is done. For example, a double click of a mouse button may open a second window, whereas a right click of a mouse button may open a yet another different window. In addition, in this application “Hyperlink” and “Link” refer to the same thing. A hyperlink, or link, could be seen as a digital reference to data that can be followed by a user by clicking or tapping on it. Hyperlinks can be a piece of text, an image, an icon, or a graphic.

Patent search engines powered by artificial vision (or computer vision) and artificial intelligence (“Vision AI Patent Search Engines” for short) are specialized hardware and software databases and machines that allow users to search for patents and patent applications (“patent documents” for short) by various criteria (or search parameters) including keyword searches, classifications, patent number, inventor's name, images and videos etc. As discussed previously, Vision AI Patent Search Engine may analyze, interpret and understand images and videos as well. The Vision AI Patent Search Engine typically indexes patents and patent applications from various countries and regions. When a user substantially conducts a patent search, the Patent Search Engine typically creates for an end user a patent search result page (a first window or page on the screen) displaying the result of the user's patent search. Typically on the patent search result page (or window), displays more than one patent document or prior art that fits or matches the criteria entered by the end user doing the patent search. Often the patent prior art searcher may then analyze and understand inventions that are similar to his/her (or his/her client's) invention. This may be seen as being a challenging and time-consuming task to perform especially since many patent documents are multiple pages long and the drawings are generally in B&W and without further description (e.g., the patent's drawing or image elements or parts are numbered and defined inside the document). The searcher must often search, understand and evaluate multiple (10s or 100s) patent documents that are very similar to one another, looking for a needle in a haystack.

As substantially shown in FIG. 1, the visual presentation of the web patent document 12 may contain an invention identification information 18, abstract 14 (e.g., invention summary) drawings 16, specification (not shown), claim 22 and the like. The specification may be seen as a factual explanation of how to make and use the respective invention of the patent document. The specification may set forth what the problem is the invention is trying to solve; a brief description or summary of the invention, a brief description of how the invention attempts to solve the problem, more detailed description of the invention (e.g., what are the invention's parts, how they work together, what they produce or make, etc.; a method or process of steps showing how the invention operates etc.).

The drawings 16 may display the parts, steps and other relevant information of the Specification. Elements of the drawings 16 may be numbered to reference the parts and steps as numbered in the Specification. Claim 22 are numbered sentences which set forth the legal description of the invention. The claims are the language that the patent examiner generally uses to determine whether or not the invention as put forth by the patent application is entitled to the 20-year monopoly granted by the respective government in return for the inventor(s) disclosing their invention to the public. If the invention is deemed worthy of the 20-year monopoly, the claims may then be used to determine which variations of the disclosed invention may be protected by the said governmental monopoly.

Additionally, web patent documents 12, may have additional electronic functions that the original published paper patent document may not have. For the AI Patent Search Engine (for example Google's patent search engine) may provide the web patent document with multiple original links (or hyperlinks) 20 to present additional visual displays of information relating to various subjects (e.g., prior art patents, other publications, cited references, other patents or published patent applications that may share a common inventor, etc.) These links 20 may, in keeping with the main body of the web patent documents, generally do not reference sales and commercialization information or further illustrate what the invention is in easily understood terms (e.g., layman's terms), polychromatic illustrations or other polychromatic visual media. Comprehensively, the web patent document is generally limited to information and black and white (B&W for short) patent drawings presented by the original patent/published patent application document as published and issued by the respective patent office.

One possible problem with the current art could be that many laypersons (e.g., persons generally that may not be skilled or knowledgeable in how to draft and prosecute a patent application) may not know how to read or understand a lengthy Black &White (B&W) patent document, or in particular the patent document's claims language (e.g., the patent document's legal description of the boundaries of invention) to fully understand and know the breadth of the invention as set forth by a patent document. The drawings, if provided with the patent document, generally are B&W line drawings generally lacking in shading and other three-dimensional art effects that may enhance a layperson's understanding of the respective invention. Furthermore, moving polychromatic images or pictures and other visual media are generally not submitted to be part of the actual patent document publication in that a document format as substantially used by patent offices for patent application submission may not support those kinds of polychromatic visual media. These internet and published patent documents may contain very little information that address practical issues on how to go about commercializing the invention, effecting sales on the invention, or understanding on how to use the invention. Many of these limitations generally originate within a patent office's rules and regulations for the original filing or submission of a patent application within that patent office and are reflected in the patent office's published patent and patent application documents. The web patent document may be generally limited to that information presented by the original published patent document as issued by the respective patent office.

What could possibly address these issues could be a means by which additional information (e.g., using means not usually found in an web patent document or published paper patent document such as polychromatic text, polychromatic images, polychromatic pictures, 3D animations, video illustrations and the like) that could be linked to or directly shown web patent document display that could enhance a lay person's understanding of the associated invention as well as provide other information such as how the benefits of the invention and how the invention could be utilized. In addition, The electronic polychromatic media could include layman's terms and keywords and images/pictures and videos that are added to the database of the Vision AI Patent Search Engine to continuously improve the accuracy of patent search results for end users. Such media could be embodied in electronic invention sell sheet accessible though a Vision AI Patent Search Engine provided links with patent/published patent application search result web page. Activating said link(s) could access the electronic invention sell sheets that are directed to companies that may be interested in improving their products and services. The inventor's sell sheet could be used to sell CEO and owners of said companies, in layperson terms, a new invention's benefits and advantages over existing technology.

### SUMMARY OF ONE EMBODIMENT OF THE INVENTION

### Advantages of One or More Embodiments of the Present Invention

The various embodiments of the present invention may, but do not necessarily, achieve one or more of the following advantages:
the ability to, by a single user input on the patent document or on the patent search result page, generally open a second window (or sub-window) displaying a polychromatic sell sheet or an element therein (such as for example a polychromatic image, title, etc. . . . ) that in layman's terms may concisely describe the invention, the problem the invention may solves and invention's main benefits, utilizing information and data otherwise not shown in the web patent document or the patent search result page or window as published by a patent office, such as polychromatic pictures, 3D images, 3D polychromatic animation, virtual prototype, audio and/or video clips to substantially provide a layperson with a quicker and greater understanding of the associated invention and the invention's main benefits as an alternative to having to read the multiple pages of the B&W web patent document and its B&W patent drawings using numerals to identify parts of the drawing.
to provide a revenue source for the AI Patent Search Engine wherein the AI Patent Search Engine may collect a fee from the inventor, assignee or patent owner for generally creating a link on the web patent document display (and—or its associated patent search result page) to the associated invention's enhanced information (e.g., sell sheet having invention explanations, invention purchase information, art media such as video clips or both describing or illustrating the invention in layman's terms) and to generally give the Vision AI Patent Search Engine the option to add-include layman's terms and keywords and polychromatic images, videos, etc., used in the associated electronic sell sheet to the Vision AI Patent Search Engine's database, thereby creating more comprehensive, relevant and the ability to by a single user input (one mouse click for example) on the desired patent document or on patent search result page, open a new (second) window to substantially provide a layperson with shaded drawings, polychromatic images, still pictures, moving pictures, prototypes, animations, audio and video clips or infomercials that can explain an invention better than B&W drawings with numerals;
the ability to substantially make patent searching easier and faster by allowing a lay person prior art searcher to click (with a single user input) on the polychromatic sell sheet first, to quickly see (on a second window) and understand the essence of the invention and the said invention's main benefits without having to read the displayed web patent document; and for even faster-easier searches, to add a link to a patent's sell sheet or sell sheet elements-parts within sell sheet (such as title, polychromatic image, etc.) on patent search results page (usually displaying more than one patent documents on a page-screen or window), enabling for example, a user to by hovering over (a single user input) the title of patent document to view in a new (second) window, said patent document's sell sheet title or by hovering over (a single user input) the PDF version of patent document to see in a new (second) window, a polychromatic image of the patent document's sell sheet.
to provide a repository of invention's sell sheets linked to their corresponding web patent documents whose inventions are available for sale or licensing that may be easily searched by keywords in a Vision AI Patent Search Engine;
the ability to create a link on a difficult to understand, technical, black and white web patent document and/or (a patent document listed on a patent search result page) to a polychromatic digital sell sheet that concisely in layman's terms describes and illustrates the invention and its benefits using for example polychromatic 3D images, videos and by other means that help explain the associated invention; to clarify it further, the links on patent search result page to the sell sheets are placed next to each patent document listed on the patent search result page and the link to the polychromatic sell sheet may also additionally be posted on the sell sheet's patent document itself. The format of patent document may be in PDF or other formats;
the ability to concisely explain via layman's terms the web patent document's invention, the invention's difference from the prior art, the invention's main benefits, and how the invention may solve a problem that the prior art does not, further the electronic sell sheet may be visually enticing, and may further have polychromatic images and additional links to three dimensional virtual or real prototypes, and video clips and—or video infomercials demonstrating or explaining the invention.
the ability to provide layperson's terms, keywords, drawings, videos via an invention sell sheet that may be added by AI and vision AI (that understands and can distinguish different images and videos) to the database of the Vision AI Patent Search Engine to continuously improve and increase the accuracy of patent search results for end users; and
to provide a single user input on the patent search result page listing multiple patent documents that generally fit the search parameters entered by the patent searcher, single user input may open a second window displaying a concise layperson's description of the patent document and/or with a single user input on patent search result page (first window) open a second window displaying a polychromatic image or illustration of the patent document (the invention).

These and other advantages may be realized by reference to the remaining portions of the specification, claims, and abstract.

### Brief Description of One Embodiment of the Present Invention

One possible embodiment of the invention could comprise the establishing of a link or hyperlink on a display of an web patent document of a respective invention, the internet data document located on a first database that is accessed by a Vision AI Patent Search Engine that indexes patent and published patent applications to another database containing the data forming for an associated invention's sell sheet, the sell sheet as created by the invention's inventor to enhance a layperson's understanding of the web patent document, wherein the sell sheet could be sales brochure, flier, video or other art media, a web page (such as product sale page on amazon online sales website, or a video clip or a video advertisement or infomercial further explaining the invention in layman's terms and the invention's benefits.

Another possible embodiment of the invention could comprise a computer visual display of a web patent document, the web patent documents being accessed from a web patent document database by a Vision AI Patent Search Engine that indexes patent and published patent applications, the display further allow a display such as sub window (or a second window) to present information from another database to display commercialization and sales information on the associated invention, the information created by the invention's inventor and configured and directed to enhance a lay person's understanding of the associated invention and how commercialization and sales promotion of the association invention in the marketplace may occur, wherein the commercialization and sales information may contain art media forms usually not found with in a patent document as published by a patent office.

Yet another possible embodiment of the invention could comprise a method for electronically displaying an electronic sell sheet for an invention of a web patent document, the web patent document selected by a web Vision AI Patent Search Engine based on search parameters or criteria inputted by a third party accessing the web patent document search engine through the world wide web, the method comprising the following steps: storing the electronic sell sheet upon web accessed electronic database; creating a link on the web patent document to the sell sheet; displaying web patent document, the display presenting a sell sheet area with one or more buttons; activating one button (link) of the one or more buttons to open a second window that displays the sell sheet; wherein the sell sheet display shows visual media not shown in the display of the web patent document nor in the underlying published patent document for the web patent document.

Still yet another possible embodiment of the invention could comprise a method for electronically displaying an electronic sell sheet for an invention of a web patent document, the web patent document selected by a web AI Patent Search Engine based on search parameters inputted by a third party accessing the web patent document search engine through the world wide web, the method comprising the following steps: storing the electronic sell sheet upon the web patent document electronic database or other electronic database; creating a link on the web patent document to the electronic sell sheet; displaying web patent document, the display of the web patent document further presenting a sell sheet area with one or more buttons (links); activating a button of the one or more buttons opening a first window that displays the sell sheet; wherein the sell sheet display shows information describing in layman's terms what the invention is and how it operates.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a snapshot image of a partial page of the prior art, an existing web patent document (e.g., a published patent application) as obtained from a patent database as accessed by a Vision AI Patent Search Engine.

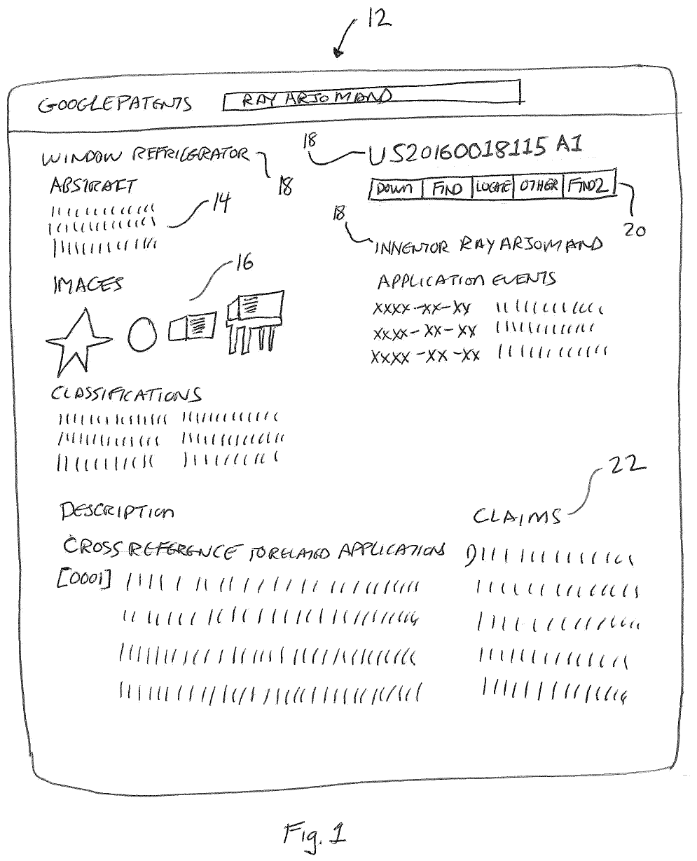

FIG. 2 is substantially a partial webpage representation of a web patent document showing one possible embodiment of the present invention when activated a hyperlink opens a window display for the present invention's Sell Sheet in one possible embodiment of the present invention.

FIG. 3 is a substantially partial webpage representation of a web patent document showing one possible embodiment of the present invention having an activated hyperlink to the respective invention's video showing the respective invention's operation.

FIG. 4 is substantially a partial webpage representation of a web patent document showing one possible embodiment of the present invention having an activated hyperlink to the respective invention's additional sales and licensing information.

FIG. 5 is substantially a flowchart schematic showing one possible embodiment of a process or method of the present invention.

FIG. 6 is substantially a partial webpage representation of a web patent document in PDF format with a “Sell Sheet” link on it.

FIG. 7 is substantially a partial webpage representation of USPTO web site's patent search result page with each listed patent document having a link to its patent document's sell sheet.

FIG. 8 is substantially partial webpage representation of google patent web site's patent search result page with each listed patent document having a link to its patent document's sell sheet.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

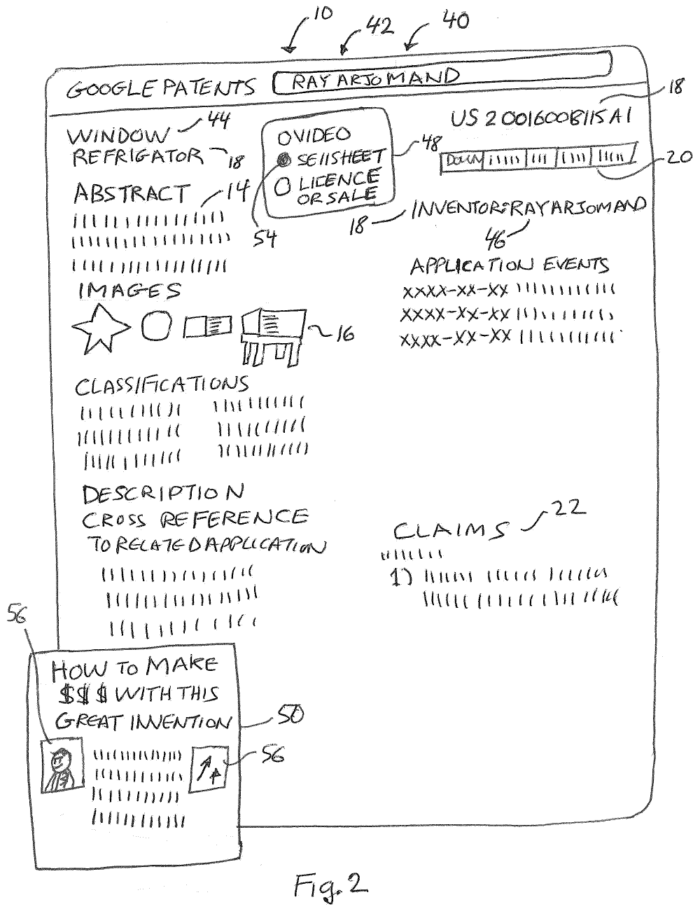

As substantially shown in FIGS. 2-8, the present invention 10 could comprise an electronic sell sheet system 40 for web patent documents and method 100, wherein the system 20 could link a web patent document 12 and electronic sell sheet 52 (e.g., a sales flier) generally a single-page document designed to provide product and service information to a potential customer.

The word “polychromatic” or multicolor as used in this application means multiple colors (more colors that just that of black against white background or black and white [“B&W” ]). For example, multiple colors such as green, red, blue, purple, orange, gray, etc. . . . against possibly multiple background colors or various computer screen polychromatic wallpapers. Although color TVs are more expensive than black and white (“B&W”) TVs, the vast majority of homes in the USA have polychromatic TVs because people in general love polychromatic and it is far superior to B&W, especially for understanding complex patent drawings, charts, videos, movies, etc. . . . . For these reasons 3D polychromatic images, virtual prototypes, animation, etc. . . . can make understanding the gist of inventions-patents (e.g., patent documents) and their main benefits much faster, and easier.

The electronic sell sheet system 40 could operate on the world wide web (i.e., web) and the internet. The web could be one of the ways that information may be shared on the internet and may be composed of billions of connected digital documents that are viewed in a web browser or search engine, supported by the internet framework, a global network of billions of servers, computers, and other electronic hardware devices.

The electronic sell sheet system 40 may work in conjunction with a patent and published patent application database(s) as generally hosted by a AI Patent Search Engine, such as Google patents, wherein the AI Patent Search Engine being connected to the world wide web operating on the internet, allows third parties to search the published patent and published patent database for desired web patent documents generally containing patent(s), published patent application(s) or both. It should be noted that patents are originally paper published documents. Not all patent applications are published, those patent applications that are published, are published in electronic format.

As substantially shown in FIG. 2, the system 40 may be offered, by a patent search engine, as a program to owners (e.g., inventors) of the published patent applications and patents found within the respective patent search engine's web patent document database. For a set fee or fees, the patent search engine may establish a link or hyperlink with the computer visual presentation of the web patent document 42 as selected by the web patent search engine according to invention search parameters or the like as inputted to the patent search engine by a third party. In response to these parameters, the web patent search engine, which indexes the said database, may retrieve and visually present (e.g., through a third party's smart device such as smartphone, tablet, computer or the like connected to the internet) from the web patent search engine a list of titles of web patent documents. When a third party clicks upon a particular title from the list, the patent search engine may visually present the respective web patent document 42. The visual presentation of the selected web patent document 42 (e.g., patent, published patent application, reissue document, or the like) may show the document information 18 (such as the name of the invention, issuance date, patent number), patent document's title 44, abstract 14 (e.g., summary of the invention), inventor names 46, (but generally not their contact information.) If the current owner of the invention of the respective web patent document agrees with the patent search engine (e.g., optionally for a fee paid to the patent search engine), the patent search engine may put near the top of the web patent document visual presentation 42 and area marked “SELL SHEET” 48 which denotes one or more link buttons or link areas (e.g., hyperlinks) that can be activated by the searching third party clicking on same.

An activation of a button could open a new window or a sub-window 50 substantially overlaid upon a portion of the web patent document visual display 42. Upon sell sheet button 54 activation, the new window 50 could display the sell sheet 52 as created by the invention owner (e.g., inventor, assignee, applicant, etc.) and as hosted by the patent search engine or the invention owner (e.g., the electronic sell sheet 52 could be linked to the respective web patent document 42.) The sell sheet 52 could use visual media 56 generally not found in the original published patent document due to limitations that may be imposed by the respective patent office rules and regulations and hence such visual media 56 is not normally found in the corresponding web patent documents. The sell sheet 52 could contain information that may assist the lay person (e.g., a patent searcher or potential purchaser of the invention) in understanding the invention of the selected web patent document. This could include additional information and the like generally not found in published patent documents, such as polychromatic drawings, instructions, 3D drawings with enhanced shading, prototype or images of actual product (invention), video illustrating the invention and the invention's benefits, information on how the associated invention could be sold and otherwise be commercialized and the like.

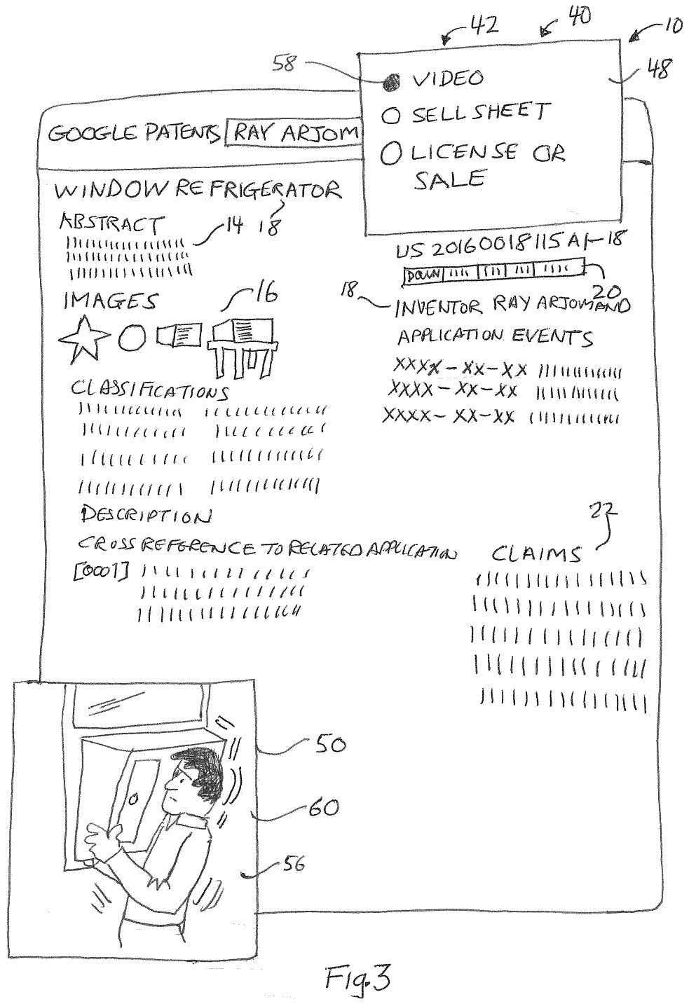

As substantially shown in FIG. 3, another button labeled “video” 58 as associated with the sell sheet area 48 could present visual displays showing other visual means such as videos 60 (e.g., infomercial), animation, rotatable three-dimensional drawings and the like as provided by the invention owner to be linked (e.g., hyperlinked) to the desired web patent document 42. These visual display files could be hosted by either the patent search engine or by the invention owner.

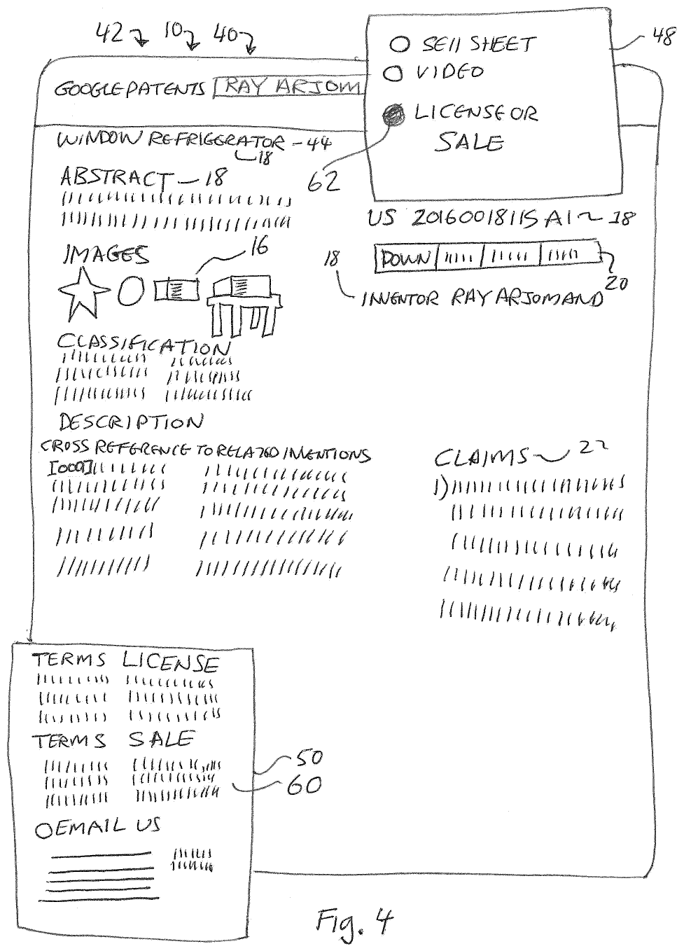

As substantially shown in FIG. 4, another button labeled “For license or sale” 62 and associated with the sell sheet area 48 could present visual displays showing the invention owner was offering to license or sell the underlying patent, published patent application or like the web patent document. This display could show lease or sale information or sales video 60 such as possible fees and sales and licensing terms that the invention owner could be looking for as well as invention owner contact information (e.g., direct email contact capability as well).

In this manner, the present invention 10 can be seen as being able to supply third parties (not shown) who are interested in a respective invention of a web patent document with easy-to-understand layman's terms to better understand the respective invention and the respective invention's use(s) and benefits as displayed in a web patent document. The present invention may utilize visual means that are not usually available with or restricted from the web patent document or the underlying published patent document. The invention may further provide license and sale terms if the invention owner or others wish to commercialize the respective invention.

### Method

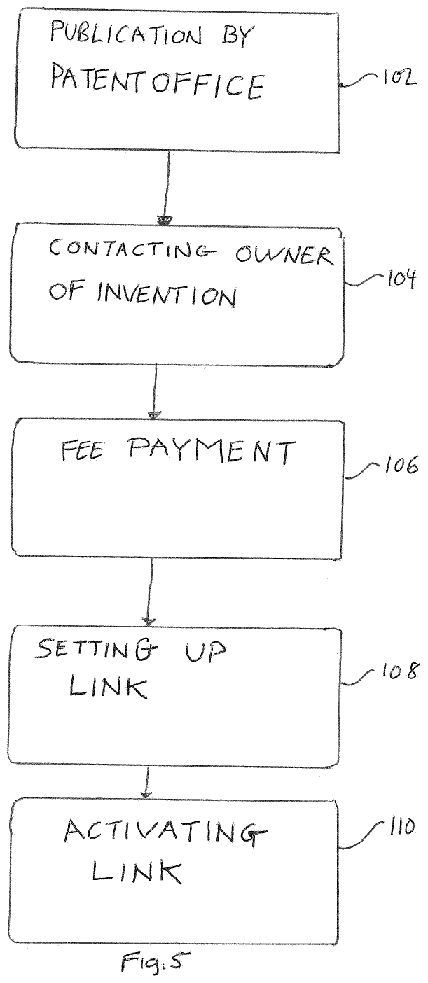

As substantially shown in FIG. 5, the method or process 100 for the invention 10 could start with step 102, publication by a patent office. In this step, after a patent application, namely a non-provisional patent application, is filed with a respective patent office (e.g., the United States Patent and Trademark Office) the said application may be published by the patent office as a published patent application if the submitted application meets certain criteria. Additionally, if the patent office decides to grant a patent upon a pending patent application, the resulting patent will be published. The inventor may optionally upload his/her patent's sell sheet to the AI Patent Search Engine before the patent is published, perhaps at the time the patent document is e-filed. Once published, the respective patent office may add the said published patent documents to the patent office's online database of web patent documents. The patent office database may be accessed by the patent-offices web patent document search engine that indexes the patent office's own web patent documents. At the time, the patent office, usually under an ongoing contract, may sell the electronic forms of the patent office's published patent documents to third-party, such as internet patent search engine companies like Google's patent search engine. When the third party uploads the newly released published patent documents to the third party's web patent documents database, the new web patent documents can be made available through the third party's web patent document search engine (free to others as the public service; pay for service through subscription, or other access arrangements.) Such third parties may have in their respective databases web patent documents from several different patent offices.

Once the published patent documents are substantially uploaded in the third party's web patent document database, the third party may have access to the basic contact information to the patent owner (e.g., inventor, assignor, etc.) inventor. Once this step is substantially concluded, process 100 could proceed to step 104 contacting the patent or published patent application owner(s).

At step 104, contacting the patent or published patent application owner(s) the patent office or web patent document database patent search engine or company may contact the owner of the invention for the selected web patent document assignee, licensee. Step 104 may occur at the time the inventor files his/her patent application (for provisional or non-provisional) with the patent office. In addition, the internet patent search engine or office may ask additional questions from the inventor (or other owner of the invention from the selected web patent document), e.g., through filling out form(s) sent to said person to find out more about the invention and inventor's needs. The form could ask such questions as: is the invention available for sale or licensing?; Does the inventor need to promote the invention to manufacturers or distributors in that particular industry or market niche?; Does the inventor need to secure financing? Answering a few questions such as those can help the web patent document search engine find out more about the invention, the market niche the invention is expecting to serve, the type of marketing help the inventor needs, etc. For example, if the inventor seeks financing, the web patent document search engine can promote the invention to others such as angel investors, banks and other sources of capital. As this step is substantially accomplished, the process 100 can move onto the next step 106, fee payment,

At step 106, fee payment, if the web patent document search engine or company wants to charge fee(s) for its services (e.g., linking the desired hosted web patent document to a sell sheet using visual media and information as supplied by the respective invention's owner; marketing services to promote the invention to that industry's manufacturers, business executives, distributors, investors, etc.) the patent search engine could forward corresponding fee(s) information and fee payment capability information for those services to the said invention owner.

If the patent search engine does not charge fee(s) or if the invention owner pays required fee(s) for the desired link service(s) then process 100 could proceed to step 108, setting up the link. If the web patent document search engine does charge fee(s) and the invention owner does not pay the required fees for desired services, then the process 100 can terminate.

At step 108, setting up the link, the invention owner (e.g., inventor, assignee, or the like) could send (via electronic format such as email attachment, e-file drop service, or the like) to the patent search engine the invention's sell sheet or alternatively a web address or URL of the web page where the sell sheet is hosted on the internet—whichever means is acceptable to the patent search engine. The sell sheet could further contain the patent application number or patent number of the invention of the desired web patent document that is the patent search engine's web patent document database so the sell sheet can be electronically linked to the said web patent document. The sell sheet could contain information that assists the lay person (e.g., a 3^{rd} party patent document searcher, a potential licensee or purchaser of the invention) in understanding the invention. This could include information and the like generally not found in published patent documents, such as polychromatic drawings, instructions, 3D drawings with enhanced shading, information on how the associated invention could be sold and otherwise be commercialized and the like. Further, associated with the sell sheet could be other visual means such videos, animation, rotatable three-dimensional drawings and the like as provided by the invention owner to be linked to the desired web patent document.

Once the link is established between the sell sheet as hosted by the web patent document search engine or as hosted the inventor owner or the like, and the web patent documents as hosted by the web patent document search engine, third parties using the patent document search engine may pull up the respective web patent document to access the linked sell sheet.

If changes need to be made upon the sell sheet, and the sell sheet is hosted by the web patent document search engine, the invention owner or like may contact the said patent search engine about making those sell sheet changes. If the sell sheet is hosted by the inventor owner, the inventor owner may make changes as necessary.

As this step is substantially completed, the process 100 could proceed to step 110, activating the link.

At step 110, activating the link, a third person may access the patent search engine and enter the search parameters for a desired invention (or other search parameters such as inventor's name or the like. The search engine may return on a visual display a list of patent documents that may fall with the selected search parameters. If the third party selects a web patent document from the list, the search engine may visually display the selected web patent document. If the web patent document is linked to a sell sheet, the visual display for the selected web patent document may show an area near the top of the web patent document entitled “sell sheet.” One or more hyperlink buttons may be located in this area. One such button may be entitled “sell sheet” and when clicked upon may open a new window or a sub-window with the web patent document showing in the background with this area. This window/sub-window may display the linked sell sheet displaying information in layman's terms about the invention, how the invention works, how the invention could be sold, how the invention is an improvement over the prior art (e.g., earlier related inventions) and the like. The linked sell sheet could employ visual media generally not found in published patent documents, such polychromatic drawings with shading, rotatable three-dimensional drawings and the like. Another such button could be video and upon activation open another window or sub window to run a demonstration sales video, video infomercial, which show how a person could use the invention and what results could be obtained by the invention in such an event. Yet another button in that area could be entitled “sales and licensing” and upon activation could open a window or sub-window having inventor owner contact information in detail as well as initial information for sale, licensing, or both as well as an email sending capability that the third party can use directly contact the invention owner.

In engaging the buttons under the Sell Sheet area of the web patent document as displayed by the system, the third party could easier gain a greater knowledge, as compared to the information just found in the published patent document, of what is the invention; how the invention works, how the invention may be deployed in the marketplace and other such issues in layman's terms with polychromatic images and videos.

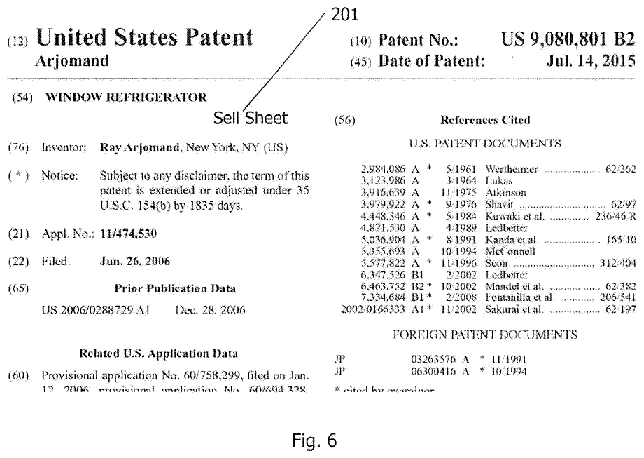

FIG. 6 is substantially a partial webpage representation of a patent document in PDF format having a link 201 to the patent document's polychromatic sell sheet. The link 201 on the patent document can be made regardless of the format the document is saved in, that is for example in PDF, MS Word, TXT, etc. With a single user input a new second window (page or sub-window or balloon window) opens displaying the sell sheet. This link on a patent document to its polychromatic sell sheet is an additional or independent link from links to polychromatic sell sheets on patent search result pages (see below).

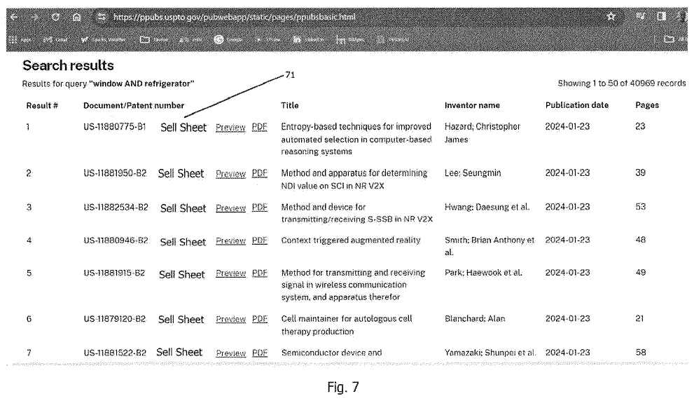

FIG. 7 is substantially a partial webpage representation of USPTO web site's patent search result page (or window) created by the AI Patent Search Engine based on criteria or search parameters entered by the patent searcher, with each (or at least one) listed patent document on the patent search result page having a link 71 to its associated patent document's sell sheet. For example, substantially activating a single user input (double click for example) on the sell sheet link 71, a new window (a second window or sub-window) may open to display the polychromatic sell sheet for that patent document. Or by simply mouse hovering (a single user input, as previously mentioned) over the sell sheet link on the patent search result page (a first window), may display an element or part within the sell sheet, such as the sell sheet's title or first polychromatic image (for example a 3D polychromatic image of the virtual prototype or an animation of the product) on a second or sub-window. For another example, mouse hovering (a single user input) over the title of the patent document (on the patent search result page, a first window) may display the title of the sell sheet on a second window or sub-window. Optionally the Vision AI Patent Search Engine adds layman's terms, keywords, polychromatic images or videos in the sell sheet (or linked to the sell sheet) to its database to continuously improve the accuracy of results of its patent searches for end users.

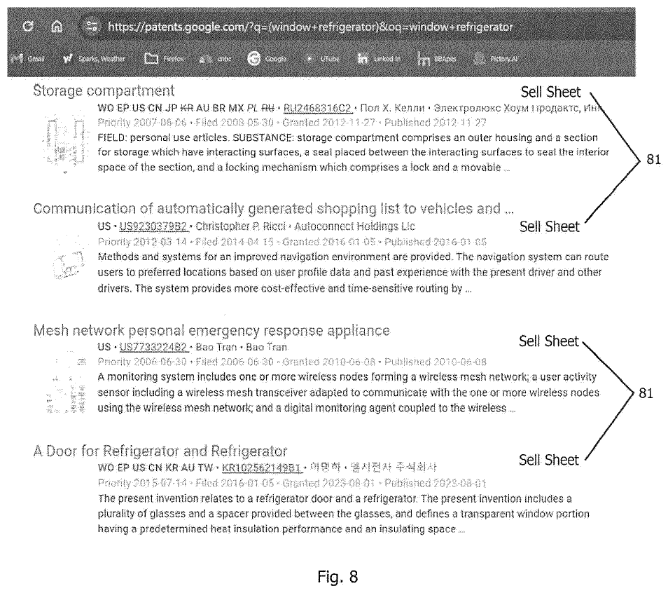

FIG. 8 is substantially a partial webpage representation of google patent web site's patent search result page (similar to above FIG. 7, USPTO's patent search result page although the display is not in a spreadsheet format) with each listed patent document having a link 81 to its associated patent document's sell sheet. With a single user input on the sell sheet link 81, a new (second) window or sub-window opens displaying the polychromatic sell sheet for that patent document. Optionally the AI Patent Search Engine adds layman's terms, keywords, polychromatic images or videos in the sell sheet to its database to continuously improve the accuracy and results of its patent searches for end users.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

1. A method for displaying an electronic polychromatic sell sheet for an invention of a web patent document, the electronic polychromatic sell sheet selected from an electronic patent document database accessible via the internet through a web-based artificial intelligence patent search engine, comprising the following steps:
(A) storing within the electronic patent document database or another different electronic database, either the electronic polychromatic sell sheet itself or a web address to said electronic polychromatic sell sheet;
(B) accessing the web-based artificial intelligence patent search engine by an end user to provide a patent search result page presented on a first window, the patent search result page further listing at least one patent document based on search parameters inputted by an end user accessing the web-based artificial intelligence patent search engine; and
(C) activating a first hyperlink by said end user with a single user input on the patent search result page to open a second window; and
(D) displaying an electronic polychromatic sell sheet through the second window, the displayed electronic polychromatic sell sheet associated with at least one of the listed patent documents on the patent search result page.

2. The method of claim 1 wherein displaying the electronic polychromatic sell sheet further displays one of the following visual displays from a group of visual displays consisting of polychromatic drawing, polychromatic photograph, or three-dimensional polychromatic animation.

3. The method of claim 1 wherein the electronic polychromatic sell sheet is presented in the form of a web page or a video clip.

4. The method of claim 1 wherein the electronic polychromatic sell sheet's content or web address is provided by an inventor, licensee, or owner of the patent document.

5. The method of claim 1 wherein the electronic polychromatic sell sheet's content is incorporated into the artificial intelligence patent search engine's database.

6. The method of claim 5 wherein the artificial intelligence patent search engine is a vision artificial patent search engine, and the content further comprises polychromatic images and videos from the sell sheet that are integrated into the database.

7. The method of claim 1 wherein the opening with a single user input further comprises the step of triggering the single user input by one or more rapid mouse clicks or a mouse hover.

8. The method of claim 1 wherein the opening a secondary window wherein comprising a step of selecting the secondary window from a set of different secondary windows, the selection of specific secondary window is based on the single users input location on the patent search result page and the type of single user input used to activate the secondary window.

9. The method of claim 1 further comprises a step of providing a secondary hyperlink within the sell sheet's patent document.

10. The method of claim 9, wherein the patent document is in PDF or other file format.

11. A patent search result page generated by an artificial intelligence patent search engine accessible via the world wide web, the artificial intelligence patent search engine having access to a database of patent documents, the patent search result page being generated based on search parameters or other criteria as provided by an end user in a first window, comprising:
(A) a listing of one or more patent documents meeting the search parameters or criteria, with at least one listed patent document further comprising at least one hyperlink to the respective patent document's polychromatic sell sheet; and
(B) the hyperlink activation through a single user input causes a second window to open and display the polychromatic sell sheet further displaying an invention title, a description of the patent document in layman's terms and visually illustrating or otherwise presenting said patent document.

12. A patent search result page of claim 11 wherein the polychromatic sell sheet further comprises polychromatic images, polychromatic pictures, polychromatic 3D animations, or polychromatic videos as accompanied by a description of the invention, the invention's benefits, and operational details in layman's terms thereby explaining or illustrating the invention with polychromatic images and video.

13. A patent search result page of claim 11 wherein the polychromatic sell sheet is presented in the form of a web page or video clip.

14. A patent search result page of claim 11 wherein the polychromatic sell sheet or polychromatic sell sheet's web address is obtained from the inventor, licensee, or owner of the patent document.

15. A patent search result page of claim 11 wherein textual content of the polychromatic sell sheet's is incorporated into the artificial intelligence patent search engine's database.

16. A patent search result page of claim 15 wherein the artificial intelligence patent search engine is a vision artificial patent search engine further having polychromatic images and polychromatic videos integrated into the database.

17. A patent search result page of claim 11 wherein the single user input can be activated by one or more rapid mouse clicks or a mouse hover.

18. A patent search result page of claim 11 wherein the activation of single user input further triggers an opening of different second window based on the location and type of single user input of the first window.

19. The electronic polychromatic sell sheet of claim 11 further providing a secondary hyperlink to access the polychromatic sell sheet, the secondary hyperlink being provided within the polychromatic sell sheet's patent document.

20. The patent document of claim 19 wherein the polychromatic sell sheet's patent document is in a PDF format.
